(19) United States
(12) Patent Application Publication
(10) Pub. No.: US 2026/0136371 A1
(43) Pub. Date: May 14, 2026

(54) CONFIGURATION DETERMINATION METHOD, CAPABILITY REPORTING METHOD, AND CYCLE CONFIGURATION METHOD

(71) Applicant: GUANGDONG OPPO MOBILE TELECOMMUNICATIONS CORP., LTD., Dongguan (CN)

(72) Inventor: Yanan LIN, Dongguan (CN)

(73) Assignee: GUANGDONG OPPO MOBILE TELECOMMUNICATIONS CORP., LTD., Dongguan (CN)

(21) Appl. No.: 19/442,921

(22) Filed: Jan. 7, 2026

Related U.S. Application Data
(63) Continuation of application No. PCT/CN2023/126040, filed on Oct. 23, 2023.

(51) Int. Cl. H04W 72/23; H04W 24/08

(52) U.S. Cl. CPC H04W 72/23; H04W 24/08

(57) ABSTRACT

A configuration determination method and a UE are provided. The method includes: receiving first DCI, the first DCI including a first information field and a second information field, and the first information field and the second information field being used for determining a first cycle configuration; a UE is configured with a number N of cycle configurations, the N cycle configurations include the first cycle configuration, and N is an integer greater than 1.

### CROSS-REFERENCE TO RELATED APPLICATION

This application is a continuation of International Patent Application No. PCT/CN2023/126040 filed on Oct. 23, 2023, the entire content of which is hereby incorporated by reference in its entirety.

### BACKGROUND

If a User Equipment (UE) is configured with a large number of period configurations and/or different types of period configurations, how to accurately and flexibly determine some period configurations among these many period configurations is a problem that needs to be solved.

### SUMMARY

Embodiments of the present disclosure provide a configuration determination method and a User Equipment (UE). The technical solutions are implemented as follows.

According to one aspect of the present disclosure, a configuration determination method is provided. The method is performed by a User Equipment (UE), and includes the following operations.

A first Downlink Control Information (DCI) is received. The first DCI includes a first information field and a second information field, and the first information field and the second information field are used to determine a first period configuration.

The UE is configured with N sets of period configurations. The N sets of period configurations include the first period configuration. N is an integer greater than 1.

According to one aspect of the present disclosure, a User Equipment (UE) is provided. The UE includes a processor and a memory configured to store instructions executable by the processor. The processor is configured to load and execute the instructions to implement the configuration determination method according to the above aspect.

### BRIEF DESCRIPTION OF THE DRAWINGS

In order to more clearly illustrate the technical solutions in the embodiments of the present disclosure, the following briefly describes the accompanying drawings required for describing the embodiments. Apparently, the accompanying drawings in the following description show only some embodiments of the present disclosure, and those skilled in the art may still derive other drawings from these accompanying drawings without creative efforts.

FIG. 1 is a schematic diagram of a mobile communication system according to some illustrative embodiments of the present disclosure.

FIG. 2 is a schematic flowchart of a configuration determination method according to some illustrative embodiments of the present disclosure.

FIG. 3 is a schematic flowchart of a configuration determination method according to some illustrative embodiments of the present disclosure.

FIG. 4 is a schematic flowchart of a configuration determination method according to some illustrative embodiments of the present disclosure.

FIG. 5 is a schematic flowchart of a configuration determination method according to some illustrative embodiments of the present disclosure.

FIG. 6 is a schematic flowchart of a capability reporting method according to some illustrative embodiments of the present disclosure.

FIG. 7 is a schematic flowchart of a period configuration method according to some illustrative embodiments of the present disclosure.

FIG. 8 is a schematic flowchart of a capability reporting and period configuration method according to some illustrative embodiments of the present disclosure.

FIG. 9 is a schematic flowchart of a configuration determination method according to some illustrative embodiments of the present disclosure.

FIG. 10 is a schematic flowchart of a capability reporting method according to some illustrative embodiments of the present disclosure.

FIG. 11 is a schematic flowchart of a period configuration method according to some illustrative embodiments of the present disclosure.

FIG. 12 is a schematic flowchart of a capability reporting and period configuration method according to some illustrative embodiments of the present disclosure.

FIG. 13 is a schematic flowchart of a configuration determination method according to some illustrative embodiments of the present disclosure.

FIG. 14 is a structural block diagram of a configuration determination apparatus according to some illustrative embodiments of the present disclosure.

FIG. 15 is a structural block diagram of a capability reporting apparatus according to some illustrative embodiments of the present disclosure.

FIG. 16 is a structural block diagram of a period configuration apparatus according to some illustrative embodiments of the present disclosure.

FIG. 17 is a structural block diagram of a configuration determination apparatus according to some illustrative embodiments of the present disclosure.

FIG. 18 is a structural block diagram of a capability reporting apparatus according to some illustrative embodiments of the present disclosure.

FIG. 19 is a structural block diagram of a period configuration apparatus according to some illustrative embodiments of the present disclosure.

FIG. 20 is a schematic structural diagram of a communication device according to some illustrative embodiments of the present disclosure.

### DETAILED DESCRIPTION

To make the objectives, technical solutions, and advantages of the present disclosure clearer, the embodiments of the present disclosure will be further described in detail below with reference to the accompanying drawings. Exemplary embodiments are described in detail here, examples of which are illustrated in the accompanying drawings. When the following description refers to the drawings, the same numerals in different drawings denote the same or similar elements unless otherwise indicated. The implementations described in the following exemplary embodiments do not represent all implementations consistent with the present disclosure. Rather, they are merely examples of apparatuses and methods consistent with some aspects of the present disclosure as detailed in the appended claims.

The terminologies used in the present disclosure are for the purpose of describing particular embodiments only and are not intended to limit the disclosure. The singular forms “a”, “said”, and “the” used in the present disclosure and the appended claims are also intended to include plural forms, unless the context clearly indicates otherwise. It should also be understood that the term “and/or” as used herein refers to and encompasses any and all possible combinations of one or more of the associated listed items.

It should be understood that although terms such as first, second, third, etc. may be used in the present disclosure to describe various types of information, the information should not be limited by these terms. These terms are only used to distinguish information of the same type from each other. For example, without departing from the scope of the present disclosure, first information may also be referred to as second information, and similarly, second information may also be referred to as first information. Depending on the context, the word “if”′ as used herein may be interpreted as “when”, “upon” or “in response to determining”.

First, the communication technologies involved in the embodiments of the present disclosure are introduced below.

### Configured Grant Physical Uplink Shared Channel Transmission (CG PUSCH Transmission):

PUSCH refers to Physical Uplink Shared Channel. CG PUSCH transmission is a semi-static uplink transmission method, which includes the following two types of CG:

Type 1 CG (Type 1 CG): The network side configures all parameters of the CG configuration for the User Equipment (UE) through a Radio Resource Control (RRC) signaling. These parameters take effect without being activated by Downlink Control Information (DCI). That is, after receiving the parameters configured by the network side, the UE can directly perform periodic PUSCH transmission.

Type 2 CG (Type 2 CG): The network side configures part of the parameters of the CG configuration for the UE through the RRC signaling. These parameters take effect after being activated by the DCI. After these parameters are activated by the DCI, the UE periodically performs the PUSCH transmission on pre-configured resources, and the number of resources occupied by each PUSCH is the same.

A CG configuration where a CG period includes only one PUSCH Occasion is called a Single-PUSCH CG Configuration. In the related art, a UE may be configured with multiple sets of Single-PUSCH CG configurations (Multiple CG Configurations), and may be configured with up to 12 sets of Single-PUSCH CG configurations. Different sets of CG configuration correspond to different transmission parameters and different indexes (ConfiguredGrantConfigIndex).

When a UE is configured with multiple sets of Type 2 CG configurations, the Hybrid Automatic Repeat Request Process Number (HARQ process number) information field in the DCI used as the activation signaling is used to indicate the index of the CG configuration activated by the DCI.

When using the DCI to deactivate the CG configurations, there are two methods: the one-to-one method and the one-to-multiple method. Specifically, in the one-to-one deactivation method, the HARQ process number information field in the DCI is used to indicate the index of the CG configuration deactivated by the DCI. In the one-to-multiple deactivation method, the network side pre-configures a deactivation configuration list (ConfiguredGrantConfigType2DeactivationStateList) through a higher layer signaling. An entry in the list includes at least one set of CG configurations. When the HARQ process number information field in the DCI used for deactivating the CG configurations indicates an entry in this list, all CG configurations included in the entry are deactivated.

### Semi-Persistent Scheduling (SPS) Configuration:

The characteristic of the SPS transmission is that both the transmission resource and the transmission method are semi-statically configured. The network device pre-configures the SPS transmission parameters (which are referred to as the SPS configuration for short) for the UE through the higher layer signaling. The DCI is used to activate/release the corresponding SPS transmission. If the corresponding SPS is activated, the subsequent transmissions do not require scheduling by physical layer signaling (such as DCI).

The network device may configure some SPS transmission parameters through the higher layer signaling, including at least one of the following: the SPS period, the time domain resource, the Physical Uplink Control Channel (PUCCH) resource used for transmitting feedback information. The feedback information may include, for example, Acknowledgement (ACK) information, Negative Acknowledgement (NACK) information, HARQ-ACK information, or HARQ-ACK codebook.

After the network device configures some SPS transmission parameters for the UE, the SPS may be activated through the DCI. The DCI may further indicate some SPS transmission parameters, including at least one of the following: the frequency domain resource, the feedback slot. The feedback slot (which is also known as the time domain offset) is denoted by k1, and is used to indicate the slot interval between the slot where the SPS Physical Downlink Shared Channel (SPS PDSCH) is located and the slot where the ACK/NACK transmission for the SPS PDSCH is located.

Generally, a UE can be configured with at most one set of SPS transmission parameters. The shortest SPS period is 10 milliseconds (ms).

### Ultra-Reliable, Low-Latency Transmission Requirements:

To support services such as Factory Automation, Transport Industry and Electrical Power Distribution, Ultra-Reliable and Low Latency Communications (URLLC), has high requirements for transmission reliability, latency, and Quality of Service (QoS).

To support Extended Reality (XR) services (e.g., Augmented Reality (AR) service, Virtual Reality (VR) service, Cloud gaming service, etc.), high requirements are also put forward for transmission reliability, latency, and QoS.

In some communication scenarios, when the data packets to be transmitted are large, the latency requirement is high and the reliability requirement is high, the aforementioned Single-PUSCH CG configuration and SPS transmission may not be able to meet such transmission requirements due to one or more factors such as transmission opportunities limitations, period limitations and transmission resource limitations.

Therefore, a CG configuration where a CG period includes multiple PUSCH opportunities is proposed. This type of CG configuration is referred to as Multi-PUSCH CG Configurations. Similarly, the SPS configurations including more transmission opportunities may also be considered.

However, a UE may be configured with a maximum of 12 sets of Single-PUSCH CG configurations. If it is also necessary to configure the UE with several sets of Multi-PUSCH CG configurations, how to accurately and flexibly indicate or determine a target CG configuration among so many CG configurations is a problem that needs to be considered.

Similarly, generally, a UE may be configured with at most one set of SPS configurations. Therefore, when it is necessary or possible to configure the UE with more SPS configurations, or even configure the UE with both traditional SPS configurations and SPS configurations including more transmission opportunities, how to accurately and flexibly indicate or determine the target SPS configuration among so many SPS configurations is also a problem that needs to be considered.

Based on the above problems, the present disclosure provides a configuration determination method, a capability reporting method, and a configuration method, which support accurate, flexible and efficient determination of some configurations from multiple configurations.

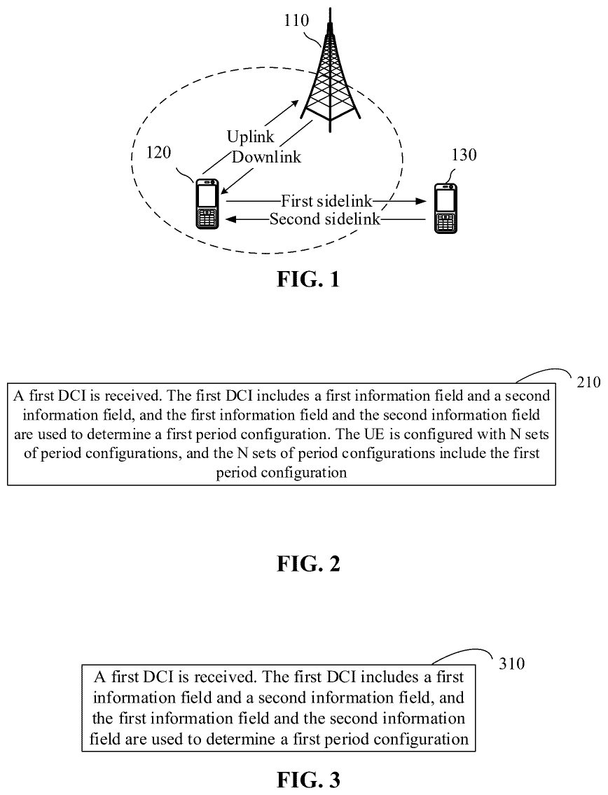

FIG. 1 shows a schematic diagram of a mobile communication system provided by an exemplary embodiment of the present disclosure. The mobile communication system includes a network device 110 and a terminal device 120, and may also include or not include a terminal device 130, which is not limited in the present disclosure.

The network device 110 in the present disclosure provides wireless communication functions. The network device 110 includes but is not limited to: an Evolved Node B (eNB), a Radio Network Controller (RNC), a Node B (NB), a Base Station Controller (BSC), a Base Transceiver Station (BTS), a home base station (e.g., Home Evolved Node B or Home Node B, HNB), a Baseband Unit (BBU), an Access Point (AP) in a Wireless Fidelity (Wi-Fi) system, a wireless relay node, a wireless backhaul node, a Transmission Point (TP), a Transmission and Reception Point (TRP), etc. It may also be a Next Generation Node B (gNB) or a Transmission Point (TRP or TP) in a 5th Generation (5G) mobile communication system, or one antenna panel or a group of antenna panels (including multiple antenna panels) of a base station in a 5G system, or a network node constituting a gNB or a Transmission Point, such as a Baseband Unit (BBU) or a Distributed Unit (DU), or a base station in a Beyond Fifth Generation (B5G) or 6th Generation (6G) mobile communication system, or a Core Network (CN), Fronthaul, Backhaul, Radio Access Network (RAN), network slicing, etc., or a serving cell of a terminal device, a Primary Cell (PCell), a Primary Secondary Cell (PSCell), a Special Cell (SpCell), a Secondary Cell (SCell), a neighboring cell, etc.

The terminal device 120 in the present disclosure may also be referred to as User Equipment (UE), access terminal, subscriber unit, subscriber station, mobile station, mobile platform, remote station, remote terminal, mobile device, user terminal, terminal, wireless communication device, user agent, user apparatus. The terminal includes, but is not limited to: handheld devices, wearable devices, vehicle-mounted devices, and Internet of Things devices, etc., for example: mobile phones, tablets, e-book readers, laptop portable computers, desktop computers, televisions, game consoles, Mobile Internet Devices (MID), Augmented Reality (AR) terminals, Virtual Reality (VR) terminals, Mixed Reality (MR) terminals, Extended Reality (XR) terminals, Baffle Reality (BR) terminals, Cinematic Reality (CR) terminals, Deceive Reality (DR) terminals, wearable devices, handles, electronic labels, controllers, wireless terminals in Industrial Control, wireless terminals in Self Driving, wireless terminals in Remote Medical, wireless terminals in Smart Grid, wireless terminals in Transportation Safety, wireless terminals in Smart City, wireless terminals in Smart Home, wireless terminals in Remote Medical Surgery, cellular phones, cordless phones, Session Initiation Protocol (SIP) phones, Wireless Local Loop (WLL) stations, Personal Digital Assistants (PDA), Set Top Boxes (STB), Customer Premise Equipment (CPE), etc.

The network device 110 and the terminal device 120 communicate with each other through an air interface technology, such as a Uu interface.

Exemplarily, there are two communication scenarios between the network device 110 and the terminal device 120: an uplink communication scenario and a downlink communication scenario. The uplink communication (which may also be referred to as uplink transmission) refers to sending signals or data to the network device 110. The downlink communication (which may also be referred to as downlink transmission) refers to sending signals or data to the terminal device 120.

The terminal device 120 and the terminal device 130 communicate with each other through an air interface technology, such as a PC5 interface.

In some embodiments, there are two communication scenarios between the terminal device 120 and the terminal device 130: a first sidelink communication scenario and a second sidelink communication scenario. The first sidelink communication refers to sending signals to the terminal device 130, and the second sidelink communication refers to sending signals to the terminal device 120.

Both the terminal device 120 and the terminal device 130 are within network coverage and located in the same cell. Alternatively, both the terminal device 120 and the terminal device 130 are within the network coverage but located in different cells. Alternatively, the terminal device 120 is within the network coverage but the terminal device 130 is outside the network coverage.

The technical solutions provided in the embodiments of the present disclosure may be applied to various communication systems, for example: Global System of Mobile communication (GSM) system, Code Division Multiple Access (CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD) system, Advanced Long Term Evolution (LTE-A) system, Universal Mobile Telecommunication System (UMTS), Worldwide Interoperability for Microwave Access (WiMAX) communication system, 5G mobile communication system, New Radio (NR) system, an evolved system of the NR system, LTE-based access to unlicensed spectrum (LTE-U) system, NR-based access to unlicensed spectrum (NR-U) system, Terrestrial Networks (TN) system, Non-Terrestrial Networks (NTN) system, Wireless Local Area Networks (WLAN), Wi-Fi system, cellular IoT system, cellular passive IoT system. They can also be applied to evolved systems subsequent to the 5G NR system, as well as B5G, 6G, and subsequent evolved systems. In some embodiments of the present application, “NR” may also be referred to as a 5G NR system or a 5G system. The 5G mobile communication system may include Non-Standalone (NSA) and/or Standalone (SA) architectures.

The technical solutions provided in the embodiments of the present disclosure may also be applied to Machine Type Communication (MTC), Long Term Evolution-Machine (LTE-M) technology, Device to Device (D2D) network, Machine to Machine (M2M) network, Internet of Things (IoT) network, or other networks. The IoT network may include, for example, the Internet of Vehicles. The communication methods in the Internet of Vehicles system are collectively referred to as Vehicle to Everything (V2X, where X can represent anything), for example, the V2X may include: Vehicle to Vehicle (V2V) communication, Vehicle to Infrastructure (V21) communication, Vehicle to Pedestrian (V2P) communication, or Vehicle to Network (V2N) communication, etc.

The mobile communication system provided by the embodiments of the present disclosure may be applied to, but not limited to, at least one of the following communication scenarios: uplink communication scenario, downlink communication scenario, or sidelink communication scenario.

FIG. 2 shows a schematic flowchart of a configuration determination method provided by some exemplary embodiments of the present disclosure. The method is illustratively described by taking the method being performed by the terminal device 120 shown in FIG. 1 as an example. The method includes at least part of the following operations.

Operation 210: A first DCI is received. The first DCI includes a first information field and a second information field, and the first information field and the second information field are used to determine a first period configuration. The UE is configured with N sets of period configurations, and the N sets of period configurations include the first period configuration. N is an integer greater than 1.

In some embodiments, the first period configuration is one or more period configurations among the N sets of period configurations.

In summary, the method provided by the embodiments of the present disclosure realizes the determination of the first period configuration through the first information field and the second information field of the first DCI. Compared with the method of using only one information field to determine the first period configuration, since two information fields include more bits, the determination of more sets of period configurations can be realized accurately and efficiently, and there is higher flexibility when determining the period configurations.

FIG. 3 shows a schematic flowchart of a configuration determination method provided by some exemplary embodiments of the present disclosure. The description is given by taking the execution of the method by the terminal device 120 shown in FIG. 1 as an example. The method includes at least part of the following operations.

Operation 310: A first DCI is received. The first DCI includes a first information field and a second information field, and the first information field and the second information field are used to determine a first period configuration.

The UE is configured with N sets of period configurations. The N sets of period configurations include the first period configuration. N is an integer greater than 1.

Optionally, N is an integer less than or equal to 16. Optionally, N is an integer less than or equal to 24. Optionally, N is an integer less than or equal to 32. Optionally, N is an integer less than or equal to 64.

In some embodiments, the N sets of period configurations include a first-type period configuration, and/or a second-type period configuration.

A period determined according to the first-type period configuration includes multiple transmission opportunities, and a period determined according to the second-type period configuration includes one transmission opportunity.

In some embodiments, the N sets of period configurations are CG configurations, then the first-type period configuration may be referred to as a first-type CG configuration, and the second-type period configuration may be referred to as a second-type CG configuration. A period determined according to the first-type CG configuration includes multiple uplink transmission opportunities, such as multiple PUSCH transmission opportunities, and a period determined according to the second-type CG configuration includes one uplink transmission opportunity, such as one PUSCH transmission opportunity.

In some embodiments, the N sets of period configurations are SPS configurations, then the first-type period configuration may be referred to as a first-type SPS configuration, and the second-type period configuration may be referred to as a second-type SPS configuration. A period determined according to the first-type SPS configuration includes multiple transmission opportunities, and a period determined according to the second-type SPS configuration includes one transmission opportunity. Optionally, the transmission opportunities included in one period may include uplink transmission opportunities and/or downlink transmission opportunities. The uplink transmission opportunities may include, for example, PUSCH transmission opportunities, and the downlink transmission opportunities may include, for example, PDSCH transmission opportunities.

In some embodiments, in a case that the first DCI is used to activate a period configuration, the first information field and the second information field are used to determine the activated first period configuration.

In some embodiments, in a case that the first DCI is used to deactivate a period configuration, the first information field and the second information field are used to determine the deactivated first period configuration.

The First Information Field and the Second Information Field are Used to Determine the First Period Configuration, which May at Least Include the Following Two Determination Methods.

First determination method: The first information field and the second information field are used to determine number information of the first period configuration.

Second second determination method: The first information field is used to determine number information of the first period configuration, and the second information field is used to determine number group information or type information of the first period configuration.

### First, the First Determination Method is Introduced.

In some embodiments, N is an integer greater than or equal to 16.

In some embodiments, the N sets of period configurations correspond to one number group, or one number space, or one number resource pool, or one number list. This number group or number space or number resource pool or number list includes T numbers, and T is greater than or equal to N.

In some embodiments, the number of one set of period configurations among the N sets of period configurations ranges from 0 to T. T is greater than or equal to N-1.

In some embodiments, the N sets of period configurations include a second period configuration and a third period configuration. A number of the second period configuration is different from a number of the third period configuration. The second period configuration is any one of the N sets of period configurations, and the third period configuration is any one of the N sets of period configurations except the second period configuration.

In some embodiments, the second period configuration belongs to the first-type period configuration, and the third period configuration also belongs to the first-type period configuration. Alternatively, the second period configuration belongs to the second-type period configuration, and the third period configuration also belongs to the second-type period configuration. Alternatively, the second period configuration belongs to the first-type period configuration, and the third period configuration belongs to the second-type period configuration. Alternatively, the second period configuration belongs to the second-type period configuration, and the third period configuration belongs to the first-type period configuration.

In some embodiments, the numbers of any two period configurations among the N sets of period configurations are different.

It can be understood that first determination method does not need to consider the type information or number group information of the first period configuration. The period configurations can be distinguished by the numbers. It can also be understood that each period configuration in the N sets of period configurations has a respective number, and a period configuration can be uniquely determined by one number. Therefore, the implementation of the first determination method is simple, and both parties receiving the first DCI can determine the first period configuration efficiently, simply, and flexibly.

In some embodiments, a bit of the first information field is a low bit, and a bit of the second information field is a high bit. Alternatively, a bit of the first information field is a high bit, and a bit of the second information field is a low bit.

In some embodiments, the first information field includes a HARQ process number information field, and the second information field includes a Redundancy Version (RV) information field.

In some embodiments, the first information field includes a HARQ process number information field, and the second information field includes an RV information field. A bit of the first information field is a low bit, and a bit of the second information field is a high bit. Such a design has good forward compatibility and is compatible with the aforementioned scheme of indicating the CG configuration index through the HARQ process number information field in the DCI. Especially when the number of the first period configuration is from 0 to 11, the value of the first information field can be the same as the value of the HARQ process number information field when indicating the CG configuration index through the HARQ process number information field in the DCI, resulting in minimal modification to the signaling.

In some embodiments, the HARQ process number information field includes 4 bits, and the RV information field includes 2 bits. It can also be understood that the HARQ process number information field occupies 4 bits, and the RV information field occupies 2 bits.

In some embodiments, the 4 bits included in the HARQ process number information field and 1 bit included in the RV information field are used to determine the number information of the first period configuration, and the other 1 bit included in the RV information field is a reserved bit. Optionally, the reserved bit is the high bit in the RV information field. It can also be understood that the number information of the first period configuration is determined based on the 4 bits included in the HARQ process number information field and 1 bit included in the RV information field, and the other 1 bit included in the RV information field is actually not used. It can also be understood that the number information of the first period configuration is determined based on the 4-bit HARQ process number information field and the 1-bit RV information field.

Exemplarily, the HARQ process number information field (4 bits) and the RV information field (1 bit or only 1 bit is used) are shown in Table 1. Each row, each column, and each cell in Table 1 can be used independently or in any combination. For example, when the value of the RV information field is “0” and the value of the HARQ process number information field is “0,0,0,0”, each number corresponds to a respective number among “1˜23”. As another example, when the value of the RV information field is “0” and the value of the HARQ process number information field is “0,0,0,1”, each number corresponds to a respective number among “0˜23” other than “1” . . . . Not all arbitrary combination modes are listed here. However, it should be understood that the correspondence between the number and the values of the HARQ process number information field as well as the RV information field is not limited to the design of Table 1. The combination of the value of the HARQ process number information field and the value of the RV information field can uniquely determine a certain number. Moreover, the value of the number can be other values besides “0˜23” and is not limited to “0˜23”.

TABLE 1
Numbers of HARQ process number information field (4 bits)
and RV information field (1 bit or only 1 bit is used)

| RV information | HARQ process | |
|---|---|---|
| field | number information field | Number |
| 0 | 0, 0, 0, 0 | 0 |
| 0 | 0, 0, 0, 1 | 1 |
| 0 | 0, 0, 1, 0 | 2 |

. . .

| | | |
|---|---|---|
| 0 | 1, 1, 1, 0 | 14 |
| 0 | 1, 1, 1, 1 | 15 |
| 1 | 0, 0, 0, 0 | 16 |

. . .

| | | |
|---|---|---|
| 1 | 0, 1, 1, 0 | 22 |
| 1 | 0, 1, 1, 1 | 23 |

. . .

| | | |
|---|---|---|
| 1 | 1, 1, 1, 1 | 31 |

In some embodiments, the 4 bits included in the HARQ process number information field and the 2 bits included in the RV information field are all used to determine the number information of the first period configuration. It can also be understood that the number information of the first period configuration is determined based on the 4 bits of the HARQ process number information field and the 2 bits of the RV information field. It can also be understood that the number information of the first period configuration is determined based on the 4-bit HARQ process number information field and the 2-bit RV information field.

For example, the HARQ process number information field (4 bits) and the RV information field (2 bits) are as shown in Table 2. Each row, each column, and each cell in Table 2 can be used independently or in any combination. For example, when the value of the RV information field is “0,0” and the value of the HARQ process number information field is “0,0,0,0”, each number corresponds to a respective number among “1˜47”. As another example, when the value of the RV information field is “0,0” and the value of the HARQ process number information field is “0,0,0,1”, each number corresponds to a respective number among “0˜47” other than “1” . . . . However, it should be understood that the correspondence between the number and the values of the HARQ process number information field as well as the RV information field is not limited to the design of Table 2. It is only required that the combination of the value of the HARQ process number information field and the value of the RV information field can uniquely determine a certain number, and the values and combinations of the two information fields are not limited to the design of Table 2. In addition, the value of the number can be other values besides “0˜47” and is not limited to “0˜47”.

TABLE 2
Numbers of HARQ process number information field
(4 bits) and RV information field (2 bits)

| RV information | HARQ process | |
|---|---|---|
| field | number information field | Number |
| 0, 0 | 0, 0, 0, 0 | 0 |
| 0, 0 | 0, 0, 0, 1 | 1 |
| 0, 0 | 0, 0, 1, 0 | 2 |
| . . . | | |
| 0, 0 | 1, 1, 1, 0 | 14 |
| 0, 0 | 1, 1, 1, 1 | 15 |
| 0, 1 | 0, 0, 0, 0 | 16 |
| . . . | | |
| 0, 1 | 0, 1, 1, 0 | 22 |
| 0, 1 | 0, 1, 1, 1 | 23 |
| 1, 0 | 0, 0, 0, 0 | 24 |
| 1, 0 | 0, 0, 0, 1 | 25 |
| 1, 0 | 0, 0, 1, 0 | 26 |
| . . . | | |
| 1, 0 | 1, 1, 1, 0 | 38 |
| 1, 0 | 1, 1, 1, 1 | 39 |
| 1, 1 | 0, 0, 0, 0 | 40 |
| . . . | | |
| 1, 1 | 0, 1, 1, 0 | 46 |
| 1, 1 | 0, 1, 1, 1 | 47 |
| . . . | | |
| 1, 1 | 1, 1, 1, 1 | 63 |

It can be understood that when the HARQ process number information field is 4 bits and the RV information field is 1 bit, the first DCI may determine the first period configuration among a maximum of 32 sets of period configurations. When the HARQ process number information field is 4 bits and the RV information field is 2 bits, the first DCI can determine the first period configuration among a maximum of 64 sets of period configurations. In simple terms, when the HARQ process number information field is 4 bits, the scenario that the RV information field is 2 bits supports determining the first period configuration among more sets of period configurations compared to the scenario that the RV information field is 1 bit.

### Next, the Second Determination Method is Introduced.

In some embodiments, the N sets of period configurations include a first-type period configuration and a second-type period configuration.

In some embodiments, the first information field is used to determine the number information of the first period configuration, and the second information field is used to determine the number group information or type information of the first period configuration.

In some embodiments, the number of the first-type period configuration corresponds to a first number group, a first number space, a first number resource pool, or a first number list, and the number of the second-type period configuration corresponds to a second number group, a second number space, a second number resource pool, or a second number list. Each number group, number space, number resource pool, or number list includes P numbers.

In some embodiments, P is less than or equal to 12, or P is less than or equal to 16, or P is less than or equal to 32.

In some embodiments, the number of the first-type period configuration is less than or equal to a first value, and the number of the second-type period configuration is less than or equal to a second value. It can also be understood that the number in the first number group is less than or equal to the first value, and the number in the second number group is less than or equal to the second value.

In some embodiments, the first value may be equal to or different from the second value. Optionally, the first value may be agreed upon by the communication protocol or configured by the network device. Optionally, the second value may be agreed upon by the communication protocol or configured by the network device.

In some embodiments, the first value is 15, and/or the second value is 15.

For example, the number in the first number group is less than or equal to 15, and the numbers in the second number group are less than or equal to 15. For example, the number of the first-type period configuration ranges from 0 to 15, and the number of the second-type period configuration also ranges from 0 to 15. For example, the number of the first-type period configuration ranges from 0 to 7, and the number of the second-type period configuration also ranges from 0 to 5. For example, the number of the first-type period configuration ranges from 0 to 11, and the number of the second-type period configuration also ranges from 0 to 13. It should be noted that the above examples of the numbers of the first-type period configuration and the second-type period configuration are only for schematic illustration and do not mean to impose limitations on the numbers of the first-type period configuration and the second-type period configuration. The number range of the first-type period configuration may also be other value ranges, and the number range of the second-type period configuration may also be other value ranges.

In some embodiments, the number group information may also be referred to as number space information, number resource pool information, or number list information.

In some embodiments, the type information is used to determine whether the first period configuration belongs to the first-type period configuration or the second-type period configuration.

In some embodiments, the bit of the first information field is a low bit, and the bit of the second information field is a high bit. Alternatively, the bit of the first information field is a high bit, and the bit of the second information field is a low bit.

In some embodiments, the first information field includes a HARQ process number information field, and the second information field includes an RV information field.

It can be understood that the second determination method needs to consider the type information or number group information of the first period configuration as well as the number of the first period configuration. It can also be understood that a period configuration can be uniquely determined only by a number and number group information, or by a number and type information.

Considering the aforementioned solution of indicating the CG configuration index through the HARQ process number information field in the DCI, when the first information field in second determination method is the HARQ process number information field, the value range of the HARQ process number information field can adopt the traditional value range. The second determination method has little impact on the high-layer signaling, and the maximum number of first-type period configurations and the maximum number of second-type period configurations can adopt the maximum number of traditional period configurations.

In some embodiments, the HARQ process number information field includes 4 bits, and the RV information field includes 2 bits. It can also be understood that the HARQ process number information field occupies 4 bits, and the RV information field occupies 2 bits.

In some embodiments, when the RV information field takes a first bit value, the number group information of the first period configuration is the first number group, or the type information of the first period configuration is the first-type period configuration. Optionally, when the RV information field is 1 bit or occupies only 1 bit, the first bit value is “0”, “1”, or another value. Optionally, when the RV information field is 2 bits or occupies 2 bits, the first bit value is “01”, “11”, or another value.

In some embodiments, when the RV information field takes a second bit value, the number group information of the first period configuration is the second number group, or the type information of the first period configuration is the second-type period configuration. Optionally, when the RV information field is 1 bit or occupies only 1 bit, the second bit value is “1”, “0”, or another value. Optionally, when the RV information field is 2 bits or occupies 2 bits, the second bit value is “00”, “10”, or another value.

In some embodiments, the 4 bits included in the HARQ process number information field are used to determine the number information of the first period configuration, and 1 bit included in the RV information field is used to determine the number group information or type information of the first period configuration. The other 1 bit included in the RV information field is a reserved bit. Optionally, the reserved bit is a high bit in the RV information field. It can also be understood that the number information of the first period configuration is determined based on the 4 bits of the HARQ process number information field, the number group information or type information of the first period configuration is determined based on 1 bit of the RV information field, and the other 1 bit included in the RV information field is not actually used. It can also be understood that the number information of the first period configuration is determined based on the 4-bit HARQ process number information field, and the number group information or type information of the first period configuration is determined based on the 1-bit RV information field.

For example, the HARQ process number information field (4 bits) and the RV information field (1 bit or only 1 bit is used) are as shown in Table 3. Each row, each column, and each cell in Table 3 can be used independently or in any combination. For example, when the value of the RV information field is “0”, the number group information is the second number group, or the type information is the second-type period configuration. As another example, when the value of the HARQ process number information field is “0,0,0,0”, each number corresponds to a respective number among “1˜15”. As another example, when the value of the HARQ process number information field is “0,0,0,1”, each number corresponds to a respective number among “0˜15” except “1” . . . . Not all arbitrary combination modes are listed here. However, it should be understood that the correspondence between the value of the RV information field and the number group information or type information is not limited to the design of Table 3, and the correspondence between the value of the HARQ process number information field and the number is not limited to the design of Table 3. It is only required that the combination of the value of the HARQ process number information field and the value of the RV information field can uniquely determine a certain number. The values and combinations of the two information fields are not limited to the design of Table 3. In addition, the value of the number can be other values besides “0˜15” and is not limited to “0˜15”.

TABLE 3
Numbers of HARQ process number information field (4 bits)
and RV information field (1 bit or only 1 bit is used)

| | | HARQ process | |
|---|---|---|---|
| RV | Number group | number | |
| information | information/Type | information | |
| field | information | field | Number |
| 0 | First number group/First-type | 0, 0, 0, 0 | 0 |
| | period configuration | | |
| 0 | First number group/First-type | 0, 0, 0, 1 | 1 |
| | period configuration | | |
| 0 | First number group/First-type | 0, 0, 1, 0 | 2 |
| | period configuration | | |

. . .

| | | | |
|---|---|---|---|
| 0 | First number group/First-type | 1, 1, 1, 0 | 14 |
| | period configuration | | |
| 0 | First number group/First-type | 1, 1, 1, 1 | 15 |
| | period configuration | | |
| 1 | Second number group/Second- | 0, 0, 0, 0 | 0 |
| | type period configuration | | |

. . .

| | | | |
|---|---|---|---|
| 1 | Second number group/Second- | 0, 1, 1, 0 | 6 |
| | type period configuration | | |
| 1 | Second number group/Second- | 0, 1, 1, 1 | 7 |
| | type period configuration | | |

. . .

| | | | |
|---|---|---|---|
| 1 | Second number group/Second- | 1, 1, 1, 1 | 15 |
| | type period configuration | | |

In some embodiments, the 4 bits included in the HARQ process number information field are used to determine the number information of the first period configuration, and the 2 bits included in the RV information field are used to determine the number group information or type information of the first period configuration. It can also be understood that the number information of the first period configuration is determined based on the 4 bits included in the HARQ process number information field, and the number group information or type information of the first period configuration is determined based on the 2 bits included in the RV information field. It can also be understood that the number information of the first period configuration is determined based on the 4-bit HARQ process number information field, and the number group information or type information of the first period configuration is determined based on the 2-bit RV information field.

Reference can be made to the correspondence between the value of the HARQ process number information field (4 bits) and the number, and the correspondence between the value of the RV information field (2 bits) and the number group information or type information. For example, when the value of the RV information field is “01”, the number group information is the first number group. When the value of the RV information field is “00”, the number group information is the second number group. As another example, when the value of the RV information field is “11”, the number group information is the first number group. When the value of the RV information field is “10”, the number group information is the second number group. For example, when the value of the HARQ process number information field is “0,0,0,0”, each number corresponds to a respective number among “0˜15”. As another example, when the value of the HARQ process number information field is “0,0,0,1”, each number corresponds to a respective number among “0˜15” . . . . Not all arbitrary combination modes are listed here. However, it should be understood that the combination of the value of the HARQ process number information field and the value of the RV information field can uniquely determine a certain number. The values and combinations of the two information fields are not limited to the examples described above. Moreover, the value of the number can be other values besides “0˜15” and is not limited to “0˜15”.

It should be noted that the “number” in the embodiments of the present disclosure may be an “index”, an “identity”, an “element”, or other numbers or symbols that can be used for distinction, which is not limited in the present disclosure.

In summary, the method provided by the embodiments of the present disclosure realizes the determination of the first period configuration through the first information field and the second information field of the first DCI. Compared with the method of using only one information field to determine the first period configuration, since two information fields include more bits, the determination of more sets of period configurations can be realized accurately and efficiently, and there is higher flexibility when determining the period configurations.

Furthermore, at least two optional determination methods are provided for the determination of the first period configuration, which greatly improves the flexibility of the method for determining the period configuration.

When using the first determination method, the implementation is simple and efficient. A period configuration can be uniquely determined by using one number. When the value of the number is 0˜11, it has good forward compatibility.

When using the second determination method, the impact on higher layer signaling is small, and it is compatible with the traditional number value range and the traditional maximum number of period configurations.

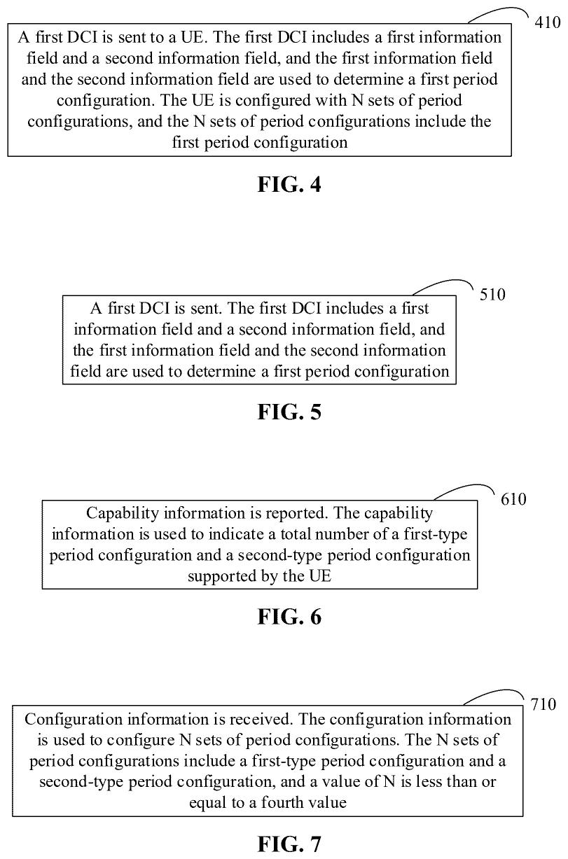

FIG. 4 shows a schematic flowchart of a configuration determination method provided by some exemplary embodiments of the present disclosure. The method is illustratively described by taking the method being performed by the network device 110 shown in FIG. 1 as an example. The method includes at least part of the following operations.

Operation 410: A first DCI is sent to a UE. The first DCI includes a first information field and a second information field, and the first information field and the second information field are used to determine a first period configuration. The UE is configured with N sets of period configurations, and the N sets of period configurations include the first period configuration.

N is an integer greater than 1.

In some embodiments, the first period configuration is one or more period configurations among the N sets of period configurations.

In summary, the method provided by the embodiments of the present disclosure realizes the determination of the first period configuration through the first information field and the second information field of the first DCI. Compared with the method of using only one information field to determine the first period configuration, since two information fields include more bits, the determination of more sets of period configurations can be realized accurately and efficiently, and there is higher flexibility when determining the period configurations.

FIG. 5 shows a schematic flowchart of a configuration determination method provided by some exemplary embodiments of the present disclosure. The method is illustratively described by taking the method being performed by the network device 110 shown in FIG. 1 as an example. The method includes at least part of the following operations.

Operation 510: A first DCI is sent. The first DCI includes a first information field and a second information field, and the first information field and the second information field are used to determine a first period configuration.

Reference can be made to operation 310 for related contents, which will not be repeated here.

In summary, the method provided by the embodiments of the present disclosure realizes the determination of the first period configuration through the first information field and the second information field of the first DCI. Compared with the method of using only one information field to determine the first period configuration, since two information fields include more bits, the determination of more sets of period configurations can be realized accurately and efficiently, and there is higher flexibility when determining the period configurations.

Furthermore, two optional determination methods for the determination of the first period configuration are provided, which greatly improves the flexibility of the method for determining the period configuration.

When using the first determination method, the implementation is simple and efficient. A period configuration can be uniquely determined by using one number. When the value of the number is 0˜11, it has good forward compatibility.

When using the second determination method, the impact on higher layer signaling is small, and it is compatible with the traditional number value range and the traditional maximum number of period configurations.

FIG. 6 shows a schematic flowchart of a capability reporting method provided by some exemplary embodiments of the present disclosure. The method is illustratively described by taking the method being performed by the terminal device 120 shown in FIG. 1 as an example. The method includes at least part of the following operations.

Operation 610: capability information is reported. The capability information is used to indicate a total number of a first-type period configuration and a second-type period configuration supported by the UE.

In some embodiments, the number of first-type period configurations supported by the UE can also be understood as the number of first-type period configurations expected by the UE. The number of second-type period configurations supported by the UE can also be understood as the number of second-type period configurations expected by the UE. The total number of first-type period configurations and second-type period configurations supported by the UE can also be understood as the total number of first-type period configurations and second-type period configurations expected by the UE.

In some embodiments, a period determined according to the first-type period configuration includes multiple transmission opportunities, and a period determined according to the second-type period configuration includes one transmission opportunity.

In some embodiments, the period configuration is a CG configuration, then the first-type period configuration may be referred to as a first-type CG configuration, and the second-type period configuration may be referred to as a second-type CG configuration. A period determined according to the first-type CG configuration includes multiple uplink transmission opportunities, such as multiple PUSCH transmission opportunities, and a period determined according to the second-type CG configuration includes one uplink transmission opportunity, such as one PUSCH transmission opportunity.

In some embodiments, the period configuration is an SPS configuration, then the first-type period configuration may be referred to as a first-type SPS configuration, and the second-type period configuration may be referred to as a second-type SPS configuration. A period determined according to the first-type SPS configuration includes multiple transmission opportunities, and a period determined according to the second-type SPS configuration includes one transmission opportunity. Optionally, the transmission opportunities included in one period may include uplink transmission opportunities and/or downlink transmission opportunities. The uplink transmission opportunities may include, for example, PUSCH transmission opportunities, and the downlink transmission opportunities may include, for example, PDSCH transmission opportunities.

In some embodiments, the total number of the first-type period configuration and the second-type period configuration supported by the UE is less than or equal to a third value.

In some embodiments, the total number of the first-type period configuration and the second-type period configuration supported by the UE is greater than a third value.

In some embodiments, the third value is an integer greater than 1.

In some embodiments, the third value is 12, 16, 24, 32 or 64.

In some embodiments, the total number of the first-type period configuration and the second-type period configuration supported by the UE is less than or equal to the third value. It can also be understood that the UE expects that the total number of the first-type period configuration and the second-type period configuration is less than or equal to the third value. It can also be understood that the UE does not expect that the total number of the first-type period configuration and the second-type period configuration is greater than the third value.

In some embodiments, the third value is agreed upon by a communication protocol, or configured by a network device.

In some embodiments, the total number of the first-type period configuration and the second-type period configuration supported by the UE is 4, 8, 10, 12 or 16.

In some embodiments, the total number of the first-type period configuration and the second-type period configuration supported by the UE is the sum of a fifth value and a sixth value. The fifth value is the number of the first-type period configuration supported by the UE or the number of the first-type period configuration expected by the UE, and the sixth value is the number of the second-type period configuration supported by the UE or the number of the second-type period configuration expected by the UE.

In some embodiments, the fifth value is less than or equal to the sixth value.

In some embodiments, the fifth value is less than or equal to a first threshold, and the sixth value is less than or equal to a second threshold. The sum of the first threshold and the second threshold is less than or equal to 16. Optionally, the first threshold is 2, 4, 8, 12 or 16. Optionally, the second threshold is 2, 4, 8, 12 or 16.

In some embodiments, the first threshold is agreed upon by a communication protocol, or configured by a network device. The second threshold is agreed upon by a communication protocol, or configured by a network device.

In summary, according to the method provided by the embodiments of the present disclosure, the capability information is reported, which enables the network device to clarify the number of the period configurations supported by the UE, so that the number of the period configurations configured by the network device for the UE better matches the UE's capability or expectation. Through the limitation on the capability information, the following problem can be avoided: the network device configures too many period configurations for the UE, resulting in the network device and the UE being unable to accurately determine some period configurations through the information fields.

FIG. 7 shows a schematic flowchart of a period configuration method provided by some exemplary embodiments of the present disclosure. The method is illustratively described by taking the method being performed by the terminal device 120 shown in FIG. 1 as an example. The method includes at least part of the following operations.

Operation 710: Configuration information is received. The configuration information is used to configure N sets of period configurations. The N sets of period configurations include a first-type period configuration and a second-type period configuration, and a value of N is less than or equal to a fourth value.

In some embodiments, a period determined according to the first-type period configuration includes multiple transmission opportunities, and a period determined according to the second-type period configuration includes one transmission opportunity.

In some embodiments, the period configuration is a CG configuration, then the first-type period configuration may be referred to as a first-type CG configuration, and the second-type period configuration may be referred to as a second-type CG configuration. A period determined according to the first-type CG configuration includes multiple uplink transmission opportunities, such as multiple PUSCH transmission opportunities, and a period determined according to the second-type CG configuration includes one uplink transmission opportunity, such as one PUSCH transmission opportunity.

In some embodiments, the period configuration is an SPS configuration, then the first-type period configuration may be referred to as a first-type SPS configuration, and the second-type period configuration may be referred to as a second-type SPS configuration. A period determined according to the first-type SPS configuration includes multiple transmission opportunities, and a period determined according to the second-type SPS configuration includes one transmission opportunity. Optionally, the transmission opportunities included in one period may include uplink transmission opportunities and/or downlink transmission opportunities. The uplink transmission opportunities may include, for example, PUSCH transmission opportunities, and the downlink transmission opportunities may include, for example, PDSCH transmission opportunities.

In some embodiments, the value of N is less than or equal to the fourth value, which can also be understood as the UE expecting the total number of the first-type period configuration and the second-type period configuration to be less than or equal to the fourth value. It can also be understood that the UE does not expect the total number of the first-type period configuration and the second-type period configuration to be greater than the fourth value.

In some embodiments, the fourth value is an integer greater than 1.

In some embodiments, the fourth value is 12, 16, 24, 32 or 64.

In some embodiments, the fourth value is agreed upon by a communication protocol, or configured by a network device.

In some embodiments, N is the sum of a seventh value and an eighth value. The seventh value is the number of the first-type period configuration configured by the network device for the UE, and the eighth value is the number of the second-type period configuration configured by the network device for the UE.

In some embodiments, the seventh value is less than or equal to the eighth value.

In some embodiments, the seventh value is less than or equal to a third threshold, and the eighth value is less than or equal to a fourth threshold. The sum of the third threshold and the fourth threshold is less than or equal to 16. Optionally, the third threshold is 2, 4, 8, 12 or 16. Optionally, the fourth threshold is 2, 4, 8, 12 or 16.

In summary, according to the method provided by the embodiments of the present disclosure, the total number of the period configurations configured by the network device is limited, which avoids the problem that the network device configures too many period configurations for the UE, resulting in the network device and the UE being unable to accurately determine some period configurations through the information fields.

FIG. 8 shows a schematic flowchart of a capability reporting and period configuration method provided by some exemplary embodiments of the present disclosure. The method is illustratively described by taking the method being performed by the terminal device 120 shown in FIG. 1 as an example. The method includes at least part of the following operations.

Operation 810: Capability information is reported. The capability information is used to indicate a total number of a first-type period configuration and a second-type period configuration supported by the UE.

Operation 830: Configuration information is received. The configuration information is used to configure N sets of period configurations, and the N sets of period configurations include a first-type period configuration and a second-type period configuration.

In some embodiments, the total number of the first-type period configuration and the second-type period configuration supported by the UE is greater than or equal to the fourth value, and the value of N is less than or equal to the fourth value. In such a case, even if the total number of the period configurations supported by the UE is greater than the fourth value, the total number of the period configurations configured by the network device for the UE can be limited to not exceed the fourth value. Through the limitation on the network device configuration, that is, through the limitation on the total number of the period configurations configured by the network device, it ensures that the period configurations configured for the UE can be determined simply and accurately through the information fields.

In some embodiments, the total number of the first-type period configuration and the second-type period configuration supported by the UE is less than or equal to the fourth value. In such a case, since the network device can know that the total number of the period configurations supported by the UE does not exceed the fourth value, it naturally will not configure more than the fourth value of the period configurations for the UE, so the value of N is naturally less than or equal to the fourth value. Through the limitation on the UE capability, that is, through the limitation on the capability information, it avoids the total number of the period configurations configured for the UE from exceeding the fourth value, thereby ensuring that the period configurations configured for the UE can be determined simply and accurately through the information fields.

In some embodiments, the total number of the first-type period configuration and the second-type period configuration supported by the UE is less than or equal to the fourth value, and the value of N is less than or equal to the fourth value. In such a case, the UE capability is restricted, and the total number of the period configurations configured by the network device is restricted, ensuring that the period configurations configured for the UE can be determined simply and accurately through the information fields.

In some embodiments, the third value and the fourth value are equal or not equal.

Optionally, the third value is agreed upon by a communication protocol, or configured by a network device. Optionally, the third value is 12, 16, 24, 32 or 64.

Optionally, the fourth value is agreed upon by a communication protocol, or configured by a network device. Optionally, the fourth value is 12, 16, 24, 32 or 64.

Optionally, the value of N is less than or equal to the total number of the first-type period configuration and the second-type period configuration supported by the UE.

Reference can be made to operation 610 for other related content of operation 810, which will not be repeated here. Reference can be made to operation 710 for other related content of operation 830, which will not be repeated here.

In summary, according to the method provided by the embodiments of the present disclosure, the UE capability and/or the total number of the period configurations configured by the network device can be limited, which avoids the problem that the network device configures too many period configurations for the UE, resulting in the network device and the UE being unable to accurately determine some period configurations through the information fields.

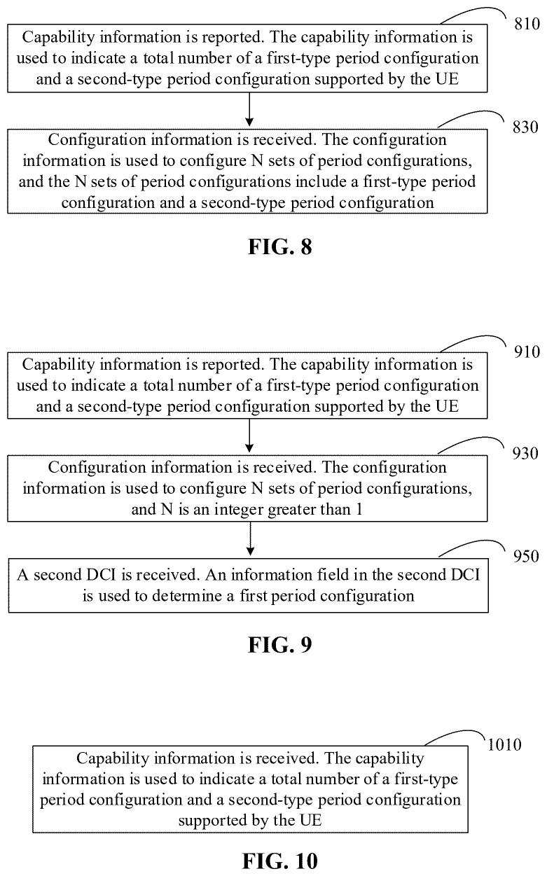

FIG. 9 shows a schematic flowchart of a configuration determination method provided by some exemplary embodiments of the present disclosure. The method is illustratively described by taking the method being performed by the terminal device 120 shown in FIG. 1 as an example. The method includes at least part of the following operations.

Operation 910: Capability information is reported. The capability information is used to indicate a total number of a first-type period configuration and a second-type period configuration supported by the UE.

Reference can be made to operation 610 for other related content, which will not be repeated here.

Operation 930: Configuration information is received. The configuration information is used to configure N sets of period configurations, and N is an integer greater than 1.

Reference can be made to operation 710 for other related content, which will not be repeated here.

In some embodiments, the N sets of period configurations include a second period configuration and a third period configuration. A number of the second period configuration is different from a number of the third period configuration. The second period configuration is any one of the N sets of period configurations, and the third period configuration is any one of the N sets of period configurations except the second period configuration.

In some embodiments, the second period configuration belongs to the first-type period configuration, and the third period configuration also belongs to the first-type period configuration. Alternatively, the second period configuration belongs to the second-type period configuration, and the third period configuration also belongs to the second-type period configuration. Alternatively, the second period configuration belongs to the first-type period configuration, and the third period configuration belongs to the second-type period configuration. Alternatively, the second period configuration belongs to the second-type period configuration, and the third period configuration belongs to the first-type period configuration.

In some embodiments, the numbers of any two period configurations among the N sets of period configurations are different.

Optionally, the number of each period configuration in the N sets of period configurations is less than or equal to 15.

Operation 950: A second DCI is received. An information field in the second DCI is used to determine a first period configuration.

In some embodiments, the first period configuration is one or more period configurations among the N sets of period configurations.

In some embodiments, the total number of the first-type period configuration and the second-type period configuration supported by the UE is less than or equal to a third value, and a first information field in the second DCI is used to determine the first period configuration.

In some embodiments, the value of N is less than or equal to a fourth value, and a first information field in the second DCI is used to determine the first period configuration.

In some embodiments, the first information field is used to determine number information of the first period configuration.

In some embodiments, the first information field includes a HARQ process number information field.

In some embodiments, the HARQ process number information field includes 4 bits.

Since the total number of the first-type period configuration and the second-type period configuration supported by the UE is limited and will not exceed the maximum number of the period configurations that can be determined by the first information field, the second DCI can use only the first information field to determine the first period configuration.

Similarly, since the value of N is limited, the total number of the period configurations configured by the network device for the UE will not exceed the maximum number of the period configurations that can be determined by the first information field, so the second DCI can use only the first information field to determine the first period configuration.

Especially when the first information field is the HARQ process number information field, the determination of the number information of the first period configuration can adopt the traditional scheme, which has little impact on the higher layer signaling and achieves the reuse of the traditional scheme. That is, there is no need to consider the type information or number group information of the first period configuration, and the period configuration can be distinguished by the number. It can also be understood that each period configuration in the N sets of period configurations has a respective number, and a period configuration can be uniquely determined by one number. Therefore, such a scheme is simple to implement, and both parties receiving the second DCI can determine the first period configuration efficiently, simply, and flexibly.

It can be understood that the case that the first information field and the second information field in the second DCI are used to determine the first period configuration in operation 950 is not excluded.

It can be understood that even if the total number of the first-type period configuration and the second-type period configuration supported by the UE is less than or equal to the third value, the number information of the first period configuration can also be determined through the first information field and the second information field.

It can be understood that even if the value of N is less than or equal to the fourth value, the number information of the first period configuration can also be determined through the first information field and the second information field.

The case that the first information field and the second information field in the second DCI are used to determine the first period configuration can be referred to “First determination method” in the embodiment shown in FIG. 3, which can be achieved by excluding certain values of the first information field and/or excluding certain values of the second information field. In other words, the design of the values of the first information field and the second information field only needs to ensure that the combination of values of the first information field and the second information field can uniquely determine a certain number, thereby achieving the determination of the first period configuration through the first information field and the second information field in the second DCI.

It should be noted that operation 910 is an optional operation, operation 930 is an optional operation, and operation 950 is an optional operation.

The above operations can be implemented independently. For example, operation 910 can be implemented independently as a capability reporting method, operation 930 can be implemented independently as a configuration method, and operation 950 can be implemented independently as a configuration determination method.

The above operations can be freely combined. For example, operation 910 and operation 930 can be combined to implement a configuration method, or operation 910 and operation 950 can be combined to implement a configuration determination method, or operation 930 and operation 950 can be combined to implement a configuration determination method, or operation 910, operation 930, and operation 950 can be combined to implement a configuration determination method.

The execution order of the above operations can be adjusted according to the actual situation.

In summary, according to the method provided by the embodiments of the present disclosure, the UE capability and/or the total number of the period configurations configured by the network device can be limited, which avoids the problem that the network device configures too many period configurations for the UE, resulting in the network device and the UE being unable to accurately determine some period configurations through the information fields. Moreover, determining the first period configuration through the first information field in the DCI can be supported, which is simple and efficient to implement, has little impact on higher layer signaling, and has good forward compatibility.

In some embodiments, the embodiment shown in FIG. 2 and the embodiment shown in FIG. 6 can be used in combination, that is, the UE at least performs operation 610 and operation 210.

In some embodiments, the embodiment shown in FIG. 3 and the embodiment shown in FIG. 6 can be used in combination, that is, the UE at least performs operation 610 and operation 310.

In some embodiments, the embodiment shown in FIG. 2 and the embodiment shown in FIG. 7 can be used in combination, that is, the UE at least performs operation 710 and operation 210.

In some embodiments, the embodiment shown in FIG. 3 and the embodiment shown in FIG. 7 can be used in combination, that is, the UE at least performs operation 710 and operation 310.

In some embodiments, the embodiment shown in FIG. 2 and the embodiment shown in FIG. 8 can be used in combination, that is, the UE at least performs operation 810, operation 830, and operation 210.

In some embodiments, the embodiment shown in FIG. 3 and the embodiment shown in FIG. 8 can be used in combination, that is, the UE at least performs operation 810, operation 830, and operation 310.

In some embodiments, the embodiment shown in FIG. 2 and the embodiments shown in FIG. 6 and FIG. 7 can be used in combination, that is, the UE at least performs operation 610, operation 710, and operation 210.

In some embodiments, the embodiment shown in FIG. 3 and the embodiments shown in FIG. 6 and FIG. 7 can be used in combination, that is, the UE at least performs operation 610, operation 710, and operation 310.

FIG. 10 shows a schematic flowchart of a capability reporting method provided by some exemplary embodiments of the present disclosure. The method is illustratively described by taking the method being performed by the network device 110 shown in FIG. 1 as an example. The method includes at least part of the following operations.

Operation 1010: Capability information is received. The capability information is used to indicate a total number of a first-type period configuration and a second-type period configuration supported by the UE.

Reference can be made to operation 610 for related contents, which will not be repeated here.

In summary, the method provided by the embodiments of the present disclosure enables the network device to clarify the number of the period configurations supported by the UE through the capability information, so that the number of the period configurations configured by the network device for the UE better matches the UE's capability or expectation. Through the limitation on the capability information, the following problem can be avoided: the network device configures too many period configurations for the UE, resulting in the network device and the UE being unable to accurately determine some period configurations through the information fields.

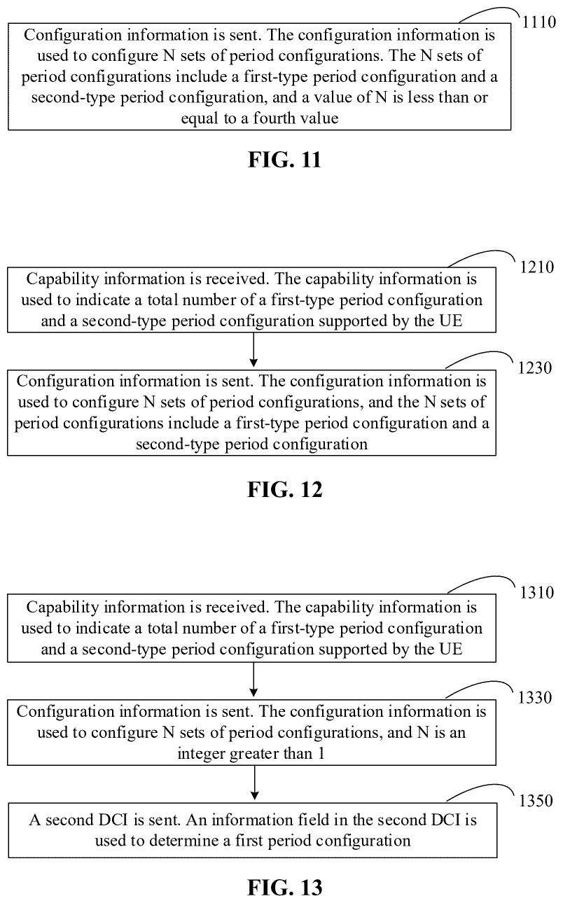

FIG. 11 shows a schematic flowchart of a period configuration method provided by some exemplary embodiments of the present disclosure. The method is illustratively described by taking the method being performed by the network device 110 shown in FIG. 1 as an example. The method includes at least part of the following operations.

Operation 1110: Configuration information is sent. The configuration information is used to configure N sets of period configurations. The N sets of period configurations include a first-type period configuration and a second-type period configuration, and a value of N is less than or equal to a fourth value.

Reference can be made to operation 710 for related contents, which will not be repeated here.

In summary, according to the method provided by the embodiments of the present disclosure, the total number of the period configurations configured by the network device is limited, which avoids the problem that the network device configures too many period configurations for the UE, resulting in the network device and the UE being unable to accurately determine some period configurations through the information fields.

FIG. 12 shows a schematic flowchart of a capability reporting and period configuration method provided by some exemplary embodiments of the present disclosure. The method is illustratively described by taking the method being performed by the network device 110 shown in FIG. 1 as an example. The method includes at least part of the following operations.

Operation 1210: Capability information is received. The capability information is used to indicate a total number of a first-type period configuration and a second-type period configuration supported by the UE.

Operation 1230: Configuration information is sent. The configuration information is used to configure N sets of period configurations, and the N sets of period configurations include a first-type period configuration and a second-type period configuration.

Reference can be made to operation 610 and operation 810 for related contents of operation 1210, which will not be repeated here. Reference can be made to operation 710 and operation 830 for related contents of operation 1230, which will not be repeated here.

In summary, according to the method provided by the embodiments of the present disclosure, the UE capability and/or the total number of the period configurations configured by the network device can be limited, which avoids the problem that the network device configures too many period configurations for the UE, resulting in the network device and the UE being unable to accurately determine some period configurations through the information fields.

FIG. 13 shows a schematic flowchart of a configuration determination method provided by some exemplary embodiments of the present disclosure. The method is illustratively described by taking the method being performed by the network device 110 shown in FIG. 1 as an example. The method includes at least part of the following operations.

Operation 1310: Capability information is received. The capability information is used to indicate a total number of a first-type period configuration and a second-type period configuration supported by the UE.

Reference can be made to operation 610 and operation 810 for related contents, which will not be repeated here.

Operation 1330: Configuration information is sent. The configuration information is used to configure N sets of period configurations, and N is an integer greater than 1.

Reference can be made to operation 710 and operation 830 for related contents, which will not be repeated here.

In some embodiments, the N sets of period configurations include a second period configuration and a third period configuration. A number of the second period configuration is different from a number of the third period configuration. The second period configuration is any one of the N sets of period configurations, and the third period configuration is any one of the N sets of period configurations except the second period configuration.

In some embodiments, the second period configuration belongs to the first-type period configuration, and the third period configuration also belongs to the first-type period configuration. Alternatively, the second period configuration belongs to the second-type period configuration, and the third period configuration also belongs to the second-type period configuration. Alternatively, the second period configuration belongs to the first-type period configuration, and the third period configuration belongs to the second-type period configuration. Alternatively, the second period configuration belongs to the second-type period configuration, and the third period configuration belongs to the first-type period configuration.

In some embodiments, the numbers of any two period configurations among the N sets of period configurations are different.

Optionally, the number of each period configuration in the N sets of period configurations is less than or equal to 15.

Operation 1350: A second DCI is sent. An information field in the second DCI is used to determine a first period configuration.

Reference can be made to operation 950 for contents related to the second DCI and the first period configuration, which will not be repeated here.

It should be noted that operation 1310 is an optional operation, operation 1330 is an optional operation, and operation 1350 is an optional operation.

The above operations can be implemented independently. For example, operation 1310 can be implemented independently as a capability reporting method, operation 1330 can be implemented independently as a configuration method, and operation 1350 can be implemented independently as a configuration determination method.

The above operations can be freely combined. For example, operation 1310 and operation 1330 can be combined to implement a configuration method, or operation 1310 and operation 1350 can be combined to implement a configuration determination method, or operation 1330 and operation 1350 can be combined to implement a configuration determination method, or operation 1310, operation 1330 and operation 1350 can be combined to implement a configuration determination method.

The execution order of the above operations can be adjusted according to the actual situation.

In summary, according to the method provided by the embodiments of the present disclosure, the UE capability and/or the total number of the period configurations configured by the network device can be limited, which avoids the problem that the network device configures too many period configurations for the UE, resulting in the network device and the UE being unable to accurately determine some period configurations through the information fields. Moreover, determining the first period configuration through the first information field in the DCI can be supported, which is simple and efficient to implement, has little impact on higher layer signaling, and has good forward compatibility.

In some embodiments, the embodiment shown in FIG. 4 and the embodiment shown in FIG. 10 can be used in combination, that is, the network device at least performs operation 1010 and operation 410.

In some embodiments, the embodiment shown in FIG. 5 and the embodiment shown in FIG. 10 can be used in combination, that is, the network device at least performs operation 1010 and operation 510.

In some embodiments, the embodiment shown in FIG. 4 and the embodiment shown in FIG. 11 can be used in combination, that is, the network device at least performs operation 1110 and operation 410.

In some embodiments, the embodiment shown in FIG. 5 and the embodiment shown in FIG. 11 can be used in combination, that is, the network device at least performs operation 1110 and operation 510.

In some embodiments, the embodiment shown in FIG. 4 and the embodiment shown in FIG. 12 can be used in combination, that is, the network device at least performs operation 1210, operation 1230, and operation 410.

In some embodiments, the embodiment shown in FIG. 5 and the embodiment shown in FIG. 12 can be used in combination, that is, the network device at least performs operation 1210, operation 1230, and operation 510.

In some embodiments, the embodiment shown in FIG. 4 and the embodiments shown in FIG. 10 and FIG. 11 can be used in combination, that is, the network device at least performs operation 1010, operation 1110, and operation 410.

In some embodiments, the embodiment shown in FIG. 5 and the embodiments shown in FIG. 10 and FIG. 11 can be used in combination, that is, the network device at least performs operation 1010, operation 1110, and operation 510.

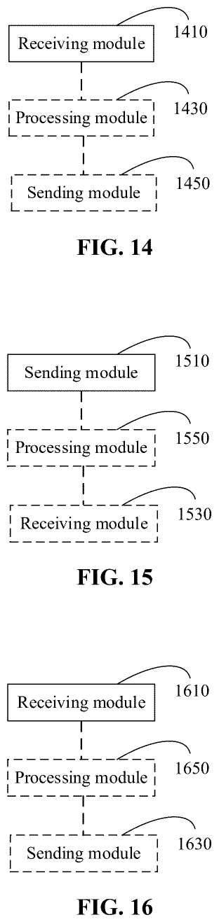

FIG. 14 shows a structural block diagram of a configuration determination apparatus provided by an exemplary embodiment of the present disclosure. The apparatus can be implemented as the terminal device shown in FIG. 2 or FIG. 3, or as part of the terminal device shown in FIG. 2 or FIG. 3. The terminal device may be the terminal device shown in FIG. 1. The apparatus includes a receiving module 1410. Optionally, the apparatus also includes a processing module 1430 and/or a sending module 1450.

The receiving module 1410 is configured to receive a first DCI. The first DCI includes a first information field and a second information field, and the first information field and the second information field are used to determine a first period configuration.

The apparatus is configured with N sets of period configurations, the N sets of period configurations include the first period configuration, and N is an integer greater than 1.

In some embodiments, the N sets of period configurations include a first-type period configuration, and/or a second-type period configuration.

A period determined according to the first-type period configuration includes multiple transmission opportunities, and a period determined according to the second-type period configuration includes one transmission opportunity.

In some embodiments, the first information field and the second information field are used to determine number information of the first period configuration.

In some embodiments, a bit of the first information field is a low bit, and a bit of the second information field is a high bit.

In some embodiments, the N sets of period configurations include a second period configuration and a third period configuration.

A number of the second period configuration is different from a number of the third period configuration, the second period configuration is any one of the N sets of period configurations, and the third period configuration is any one of the N sets of period configurations except the second period configuration.

In some embodiments, the first information field is used to determine number information of the first period configuration, and the second information field is used to determine number group information or type information of the first period configuration.

In some embodiments, a number of the first-type period configuration corresponds to a first number group, and a number of the second-type period configuration corresponds to a second number group.

In some embodiments, the number of the first-type period configuration is less than or equal to a first value, and the number of the second-type period configuration is less than or equal to a second value.

In some embodiments, the first value is 15, and/or the second value is 15.

In some embodiments, the period configuration includes a CG configuration, or an SPS configuration.

In some embodiments, the first information field includes a HARQ process number information field, and the second information field includes an RV information field.

In some embodiments, in a case that the first DCI is used to activate a period configuration, the first information field and the second information field are used to determine the activated first period configuration. Alternatively, in a case that the first DCI is used to deactivate a period configuration, the first information field and the second information field are used to determine the deactivated first period configuration.

In some embodiments, the receiving module 1410 is further configured to receive configuration information. The configuration information is used to configure the N sets of period configurations. Optionally, a value of N is less than or equal to or greater than 16.

In some embodiments, the apparatus further includes a processing module 1430, which is configured to determine the first period configuration based on the first information field and the second information field.

In some embodiments, the processing module 1430 is further configured to determine the number information of the first period configuration based on the first information field and the second information field.

In some embodiments, the processing module 1430 is further configured to determine the number information of the first period configuration based on the first information field, and determine the number group information or type information of the first period configuration based on the second information field.

In some embodiments, the apparatus further includes a sending module 1450, which is configured to report capability information. The capability information is used to indicate a total number of a first-type period configuration and a second-type period configuration supported by the apparatus, and the total number is less than or equal to or greater than 16.

In some embodiments, the receiving module 1410 is configured to perform one or more of the following operations: operation 210, operation 310, operation 710, operation 830, operation 930, and operation 950.

In some embodiments, the sending module 1450 is configured to perform one or more of the following operations: operation 610, operation 810, and operation 910.

In some embodiments, the receiving module 1410 is further configured to perform downlink transmission based on the first period configuration.

In some embodiments, the sending module 1450 is further configured to perform uplink transmission based on the first period configuration.

In summary, the apparatus provided by the embodiments of the present disclosure supports determining the first period configuration through the first information field and the second information field of the first DCI. Compared with the method of using only one information field to determine the first period configuration, since two information fields include more bits, the determination of more sets of period configurations can be accurately and efficiently achieved, and higher flexibility can be provided when determining the period configuration. Furthermore, at least two methods for determining the first period configuration can be supported, which greatly improves the flexibility of determining the period configuration.

FIG. 15 shows a structural block diagram of a capability reporting apparatus provided by an exemplary embodiment of the present disclosure. The apparatus can be implemented as the terminal device shown in FIG. 6, FIG. 8 or FIG. 9, or as part of the terminal device shown in FIG. 6, FIG. 8 or FIG. 9. The terminal device may be the terminal device shown in FIG. 1. The apparatus includes a sending module 1510. Optionally, the apparatus also includes a receiving module 1530 and/or a processing module 1550.

The sending module 1510 is configured to report capability information. The capability information is used to indicate a total number of a first-type period configuration and a second-type period configuration supported by the apparatus, and the total number is less than or equal to a third value.

In some embodiments, a period determined according to the first-type period configuration includes multiple transmission opportunities, and a period determined according to the second-type period configuration includes one transmission opportunity.

In some embodiments, the third value is 12, 16, 24, 32 or 64.

In some embodiments, the total number is 4, 8, 10, 12 or 16.

In some embodiments, the period configuration includes a CG configuration, or an SPS configuration.

In some embodiments, the sending module 1510 is configured to perform one or more of the following operations: operation 610, operation 810, and operation 910.

In some embodiments, the apparatus further includes a receiving module 1530, configured to perform one or more of the following operations: operation 210, operation 310, operation 710, operation 830, operation 930, and operation 950.

In some embodiments, the apparatus further includes a processing module 1550, which is configured to determine the first period configuration based on a first information field and a second information field. Alternatively, the processing module 1550 is configured to determine the first period configuration based on the first information field.

In some embodiments, the receiving module 1530 is further configured to perform downlink transmission based on the first period configuration.

In some embodiments, the sending module 1510 is further configured to perform uplink transmission based on the first period configuration.

In summary, according to the apparatus provided by the embodiments of the present disclosure, the capability information reported, which enables the network device to clarify the number of the period configurations supported by the apparatus, so that the number of the period configurations configured by the network device for the apparatus better matches the capability or expectation of the apparatus. Through the limitation on the capability information, the following problem can be avoided: the network device configures too many period configurations for the apparatus, resulting in the network device and the apparatus being unable to accurately determine some period configurations through the information fields.

FIG. 16 shows a structural block diagram of a period configuration apparatus provided by an exemplary embodiment of the present disclosure. The apparatus can be implemented as the terminal device shown in FIG. 7, FIG. 8 or FIG. 9, or as part of the terminal device shown in FIG. 7, FIG. 8 or FIG. 9. The terminal device may be the terminal device shown in FIG. 1. The apparatus includes a receiving module 1610. Optionally, the apparatus also includes a sending module 1630 and/or a processing module 1650.

The receiving module 1610 is configured to receive configuration information. The configuration information is used to configure N sets of period configurations.

A value of N is less than or equal to a fourth value, and the N sets of period configurations include a first-type period configuration and a second-type period configuration.

In some embodiments, a period determined according to the first-type period configuration includes multiple transmission opportunities, and a period determined according to the second-type period configuration includes one transmission opportunity.

In some embodiments, the apparatus further includes a sending module 1630, configured to report capability information. The capability information is used to indicate a total number of a first-type period configuration and a second-type period configuration supported by the apparatus, and the total number is greater than or equal to the fourth value.

In some embodiments, the fourth value is 12, 16, 24, 32 or 64.

In some embodiments, the period configuration includes a CG configuration, or an SPS configuration.

In some embodiments, the receiving module 1610 is configured to perform one or more of the following operations: operation 210, operation 310, operation 710, operation 830, operation 930, and operation 950.

In some embodiments, the sending module 1630 is configured to perform one or more of the following operations: operation 610, operation 810, and operation 910.

In some embodiments, the receiving module 1610 is further configured to perform downlink transmission based on the first period configuration.

In some embodiments, the sending module 1630 is further configured to perform uplink transmission based on the first period configuration.

In some embodiments, the apparatus further includes a processing module 1650, which is configured to determine the first period configuration based on a first information field and a second information field. Alternatively, the processing module 1650 is configured to determine the first period configuration based on the first information field.

In summary, according to the apparatus provided by the embodiments of the present disclosure, the total number of the period configurations configured by the network device is limited, which avoids the problem that the network device configures too many period configurations for the UE, resulting in the network device and the UE being unable to accurately determine some period configurations through the information fields.

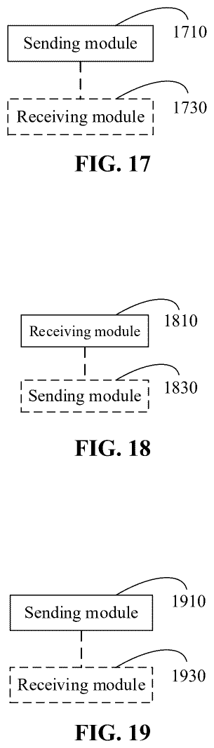

FIG. 17 shows a structural block diagram of a configuration determination apparatus provided by an exemplary embodiment of the present disclosure. The apparatus can be implemented as the network device shown in FIG. 4 or FIG. 5, or as part of the network device shown in FIG. 4 or FIG. 5. The network device may be the network device shown in FIG. 1. The apparatus includes a sending module 1710. Optionally, the apparatus also includes a receiving module 1730.

The sending module 1710 is configured to send a first DCI to a UE. The first DCI includes a first information field and a second information field, and the first information field and the second information field are used to determine a first period configuration.

The UE is configured with N sets of period configurations, the N sets of period configurations include the first period configuration, and N is an integer greater than 1.

In some embodiments, the N sets of period configurations include a first-type period configuration, and/or a second-type period configuration.

A period determined according to the first-type period configuration includes multiple transmission opportunities, and a period determined according to the second-type period configuration includes one transmission opportunity.

In some embodiments, the first information field and the second information field are used to determine number information of the first period configuration.

In some embodiments, a bit of the first information field is a low bit, and a bit of the second information field is a high bit.

In some embodiments, the N sets of period configurations include a second period configuration and a third period configuration.

A number of the second period configuration is different from a number of the third period configuration, the second period configuration is any one of the N sets of period configurations, and the third period configuration is any one of the N sets of period configurations except the second period configuration.

In some embodiments, the first information field is used to determine number information of the first period configuration, and the second information field is used to determine number group information or type information of the first period configuration.

In some embodiments, a number of the first-type period configuration corresponds to a first number group, and a number of the second-type period configuration corresponds to a second number group.

In some embodiments, the number of the first-type period configuration is less than or equal to a first value, and the number of the second-type period configuration is less than or equal to a second value.

In some embodiments, the first value is 15, and/or the second value is 15.

In some embodiments, the period configuration includes a CG configuration, or an SPS configuration.

In some embodiments, the first information field includes a HARQ process number information field, and the second information field includes an RV information field.

In some embodiments, in a case that the first DCI is used to activate a period configuration, the first information field and the second information field are used to determine the activated first period configuration. Alternatively, in a case that the first DCI is used to deactivate a period configuration, the first information field and the second information field are used to determine the deactivated first period configuration.

In some embodiments, the sending module 1710 is further configured to send configuration information. The configuration information is used to configure the N sets of period configurations. Optionally, a value of N is less than or equal to or greater than 16.

In some embodiments, the apparatus further includes a receiving module 1730, which is configured to receive capability information. The capability information is used to indicate a total number of a first-type period configuration and a second-type period configuration supported by the UE, and the total number is less than or equal to or greater than 16.

In some embodiments, the receiving module 1730 is configured to perform one or more of the following operations: operation 1010, operation 1210, and operation 1310.

In some embodiments, the sending module 1710 is configured to perform one or more of the following operations: operation 1110, operation 1230, operation 1330, and operation 1350.

In some embodiments, the receiving module 1730 is further configured to perform uplink transmission based on the first period configuration.

In some embodiments, the sending module 1710 is further configured to perform downlink transmission based on the first period configuration.

In summary, the apparatus provided by the embodiments of the present disclosure supports determining the first period configuration through the first information field and the second information field of the first DCI. Compared with the method of using only one information field to determine the first period configuration, since two information fields include more bits, the determination of more sets of period configurations can be accurately and efficiently achieved, and higher flexibility can be provided when determining the period configuration. Furthermore, at least two methods for determining the first period configuration can be supported, which greatly improves the flexibility of determining the period configuration.

FIG. 18 shows a structural block diagram of a capability reporting apparatus provided by an exemplary embodiment of the present disclosure. The apparatus can be implemented as the network device shown in FIG. 10, FIG. 12 or FIG. 13, or as part of the network device shown in FIG. 10, FIG. 12 or FIG. 13. The network device may be the network device shown in FIG. 1. The apparatus includes a receiving module 1810. Optionally, the apparatus also includes a sending module 1830.

The receiving module 1810 is configured to receive capability information reported by a UE. The capability information is used to indicate a total number of a first-type period configuration and a second-type period configuration supported by the UE, and the total number is less than or equal to a third value.

In some embodiments, a period determined according to the first-type period configuration includes multiple transmission opportunities, and a period determined according to the second-type period configuration includes one transmission opportunity.

In some embodiments, the third value is 12, 16, 24, 32 or 64.

In some embodiments, the total number is 4, 8, 10, 12 or 16.

In some embodiments, the period configuration includes a CG configuration, or an SPS configuration.

In some embodiments, the receiving module 1810 is configured to perform one or more of the following operations: operation 1010, operation 1210, and operation 1310.

In some embodiments, the sending module 1830 is configured to perform one or more of the following operations: operation 1110, operation 1230, operation 1330, and operation 1350.

In some embodiments, the receiving module 1810 is further configured to perform uplink transmission based on the first period configuration.

In some embodiments, the sending module 1830 is further configured to perform downlink transmission based on the first period configuration.

In summary, according to the apparatus provided by the embodiments of the present disclosure, the capability information is reported, which enables the apparatus to clarify the number of the period configurations supported by the UE, so that the number of the period configurations configured by the apparatus for the UE better matches the UE's capability or expectation. Through the limitation on the capability information, the following problem can be avoided: the apparatus configures too many period configurations for the UE, resulting in the apparatus and the UE being unable to accurately determine some period configurations through the information fields.

FIG. 19 shows a structural block diagram of a period configuration apparatus provided by an exemplary embodiment of the present disclosure. The apparatus may be implemented as the network device shown in FIG. 11, FIG. 12 or FIG. 13, or as part of the network device shown in FIG. 11, FIG. 12 or FIG. 13. The network device may be the network device shown in FIG. 1. The apparatus includes a sending module 1910. Optionally, the apparatus also includes a receiving module 1930.

The sending module 1910 is configured to send configuration information to a UE. The configuration information is used to configure N sets of period configurations.

A value of N is less than or equal to a fourth value, and the N sets of period configurations include a first-type period configuration and a second-type period configuration.

In some embodiments, a period determined according to the first-type period configuration includes multiple transmission opportunities, and a period determined according to the second-type period configuration includes one transmission opportunity.

In some embodiments, the apparatus further includes a receiving module 1930, which is configured to receive capability information reported by the UE. The capability information is used to indicate a total number of a first-type period configuration and a second-type period configuration supported by the UE, and the total number is greater than or equal to the fourth value.

In some embodiments, the fourth value is 12, 16, 24, 32 or 64.

In some embodiments, the period configuration includes a CG configuration, or an SPS configuration.

In some embodiments, the receiving module 1930 is configured to perform one or more of the following operations: operation 1010, operation 1210, and operation 1310.

In some embodiments, the sending module 1910 is configured to perform one or more of the following operations: operation 1110, operation 1230, operation 1330, and operation 1350.

In some embodiments, the receiving module 1930 is further configured to perform uplink transmission based on the first period configuration.

In some embodiments, the sending module 1910 is further configured to perform downlink transmission based on the first period configuration.

In summary, according to the apparatus provided by the embodiments of the present disclosure, the total number of the period configurations configured by the apparatus is limited, which avoids the problem that the apparatus configures too many period configurations for the UE, resulting in the apparatus and the UE being unable to accurately determine some period configurations through the information fields.

It should be noted that for the apparatus provided in the above embodiments, the division of the above functional modules is for illustrative purposes only. In practice, the above functions can be allocated to different functional modules as needed, i.e., the internal structure of the device can be divided into different functional modules to perform all or part of the functions described above.

Regarding the apparatus in this embodiment, the specific ways in which each module performs operations have been described in detail in the embodiments related to the method, and will not be elaborated here.

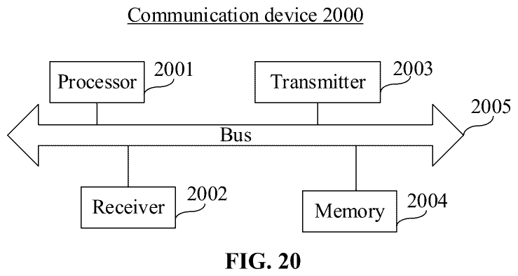

FIG. 20 shows a schematic structural diagram of a communication device (terminal device or network device) provided by some exemplary embodiments of the present disclosure. The communication device 2000 includes a processor 2001, a receiver 2002, a transmitter 2003, a memory 2004, and a bus 2005.

The processor 2001 includes one or more processing cores. The processor 2001 executes various functional applications and information processing by running software programs and modules. In some embodiments, the processor 2001 can be used to implement the functions and operations of the aforementioned processing module 1430 and/or processing module 1550 and/or processing module 1650.

The receiver 2002 and the transmitter 2003 may be implemented as one communication component, which may be a communication chip. In some embodiments, the receiver 2002 may be used to implement the functions and operations of the aforementioned receiving module 1410 and/or receiving module 1530 and/or receiving module 1610 and/or receiving module 1730 and/or receiving module 1810 and/or receiving module 1930. In some embodiments, the transmitter 2003 may be used to implement the functions and operations of the aforementioned sending module 1450 and/or sending module 1510 and/or sending module 1630 and/or sending module 1710 and/or sending module 1830 and/or sending module 1910.

The memory 2004 is connected to the processor 2001 via the bus 2005. The memory 2004 may be used to store at least one instruction, and the processor 2001 is configured to execute the at least one instruction to implement the various operations in the method embodiments described above.

Furthermore, the memory 2004 may be implemented by any type of volatile or non-volatile storage devices or a combination thereof. The volatile or non-volatile storage devices may include, but are not limited to: disks or optical disks, Electrically Erasable Programmable Read Only Memory (EEPROM), Erasable Programmable Read-Only Memory (EPROM), Static Random-Access Memory (SRAM), Read-Only Memory (ROM), magnetic memory, flash memory, Programmable Read-Only Memory (PROM).

In some embodiments, the receiver 2002 independently performs the reception of signals/data, or the processor 2001 controls the receiver 2002 to perform the reception of signals/data, or the processor 2001 requests the receiver 2002 to perform the reception of signals/data, or the processor 2001 cooperates with the receiver 2002 to perform the reception of signals/data.

In some embodiments, the transmitter 2003 independently performs the transmission of signals/data, or the processor 2001 controls the transmitter 2003 to perform the transmission of signals/data, or the processor 2001 requests the transmitter 2003 to perform the transmission of signals/data, or the processor 2001 cooperates with the transmitter 2003 to perform the transmission of signals/data.

In an exemplary embodiment of the present disclosure, a computer-readable storage medium is also provided. The computer-readable storage medium stores at least one program, and the at least one program is loaded and executed by a processor to implement the configuration determination method and/or the period configuration method and/or the capability reporting method provided by the various method embodiments described above.

In an exemplary embodiment of the present disclosure, a chip is also provided. The chip includes a programmable logic circuit and/or program instructions. When the chip runs on a communication device, it is configured to implement the configuration determination method and/or the period configuration method and/or the capability reporting method provided by the various method embodiments described above.

In an exemplary embodiment of the present disclosure, a computer program product is also provided. When the computer program product runs on a processor of a computer device, it causes the computer device to execute the configuration determination method and/or the period configuration method and/or the capability reporting method described above.

In an exemplary embodiment of the present disclosure, a computer program is also provided. The computer program includes computer instructions. A processor of a computer device is configured to execute the computer instructions, so as to cause the computer device to execute the configuration determination method and/or the period configuration method and/or the capability reporting method described above.

Embodiments of the present disclosure provide a configuration determination method, a capability reporting method, and a period configuration method. The technical solutions are implemented as follows.

According to one aspect of the present disclosure, a configuration determination method is provided. The method is performed by a User Equipment (UE), and includes the following operations.

A first Downlink Control Information (DCI) is received. The first DCI includes a first information field and a second information field, and the first information field and the second information field are used to determine a first period configuration.

The UE is configured with N sets of period configurations. The N sets of period configurations include the first period configuration. N is an integer greater than 1.

According to one aspect of the present disclosure, a capability reporting method is provided. The method is performed by a UE, and includes the following operations.

Capability information is reported. The capability information is used to indicate a total number of a first-type period configuration and a second-type period configuration supported by the UE, and the total number is less than or equal to a third value.

According to one aspect of the present disclosure, a period configuration method is provided. The method is performed by a UE, and includes the following operations.

Configuration information is received. The configuration information is used to configure N sets of period configurations.

A value of N is less than or equal to a fourth value, and the N sets of period configurations include a first-type period configuration and a second-type period configuration.

According to one aspect of the present disclosure, a configuration determination method is provided. The method is performed by a network device, and includes the following operations.

A first DCI is sent to a UE. The first DCI includes a first information field and a second information field, and the first information field and the second information field are used to determine a first period configuration.

The UE is configured with N sets of period configurations. The N sets of period configurations include the first period configuration. N is an integer greater than 1.

According to one aspect of the present disclosure, a capability reporting method is provided. The method is performed by a network device, and includes the following operations.

Capability information reported by a UE is received. The capability information is used to indicate a total number of a first-type period configuration and a second-type period configuration supported by the UE, and the total number is less than or equal to a third value.

According to one aspect of the present disclosure, a period configuration method is provided. The method is performed by a network device, and includes the following operations.

Configuration information is sent to a UE. The configuration information is used to configure N sets of period configurations.

A value of N is less than or equal to a fourth value, and the N sets of period configurations include a first-type period configuration and a second-type period configuration.

According to one aspect of the present disclosure, a configuration determination apparatus is provided. The apparatus includes a receiving module.

The receiving module is configured to receive a first DCI. The first DCI includes a first information field and a second information field, and the first information field and the second information field are used to determine a first period configuration.

The apparatus is configured with N sets of period configurations. The N sets of period configurations include the first period configuration. N is an integer greater than 1.

According to one aspect of the present disclosure, a capability reporting apparatus is provided. The apparatus includes a sending module.

The sending module is configured to report capability information. The capability information is used to indicate a total number of a first-type period configuration and a second-type period configuration supported by the apparatus, and the total number is less than or equal to a third value.

According to one aspect of the present disclosure, a period configuration apparatus is provided. The apparatus includes a receiving module.

The receiving module is configured to receive configuration information. The configuration information is used to configure N sets of period configurations.

A value of N is less than or equal to a fourth value, and the N sets of period configurations include a first-type period configuration and a second-type period configuration.

According to one aspect of the present disclosure, a configuration determination apparatus is provided. The apparatus includes sending module.

The sending module is configured to send a first DCI to a UE. The first DCI includes a first information field and a second information field, and the first information field and the second information field are used to determine a first period configuration.

The UE is configured with N sets of period configurations. The N sets of period configurations include the first period configuration. N is an integer greater than 1.

According to one aspect of the present disclosure, a capability reporting apparatus is provided. The apparatus includes a receiving module.

The receiving module is configured to receive capability information reported by a UE. The capability information is used to indicate a total number of a first-type period configuration and a second-type period configuration supported by the UE, and the total number is less than or equal to a third value.

According to one aspect of the present disclosure, a period configuration apparatus is provided. The apparatus includes a sending module.

The sending module is configured to send configuration information to a UE. The configuration information is used to configure N sets of period configurations.

A value of N is less than or equal to a fourth value, and the N sets of period configurations include a first-type period configuration and a second-type period configuration.

According to one aspect of the present disclosure, a User Equipment (UE) is provided. The UE includes a processor, a transceiver connected to the processor, and a memory configured to store instructions executable by the processor. The processor is configured to load and execute the instructions to implement the configuration determination method according to any one of the above aspects, and/or the capability reporting method according to any one of the above aspects, and/or the period configuration method according to any one of the above aspects.

According to one aspect of the present disclosure, a network device is provided. The network device includes a processor, a transceiver connected to the processor, and a memory configured to store instructions executable by the processor. The processor is configured to load and execute the instructions to implement the configuration determination method according to any one of the above aspects, and/or the capability reporting method according to any one of the above aspects, and/or the period configuration method according to any one of the above aspects.

According to one aspect of the present disclosure, a computer-readable storage medium is provided. The computer-readable storage medium is configured to store executable instructions, and the executable instructions are loaded and executed by a processor to implement the configuration determination method according to any one of the above aspects, and/or the capability reporting method according to any one of the above aspects, and/or the period configuration method according to any one of the above aspects. According to one aspect of the present disclosure, a computer program product is provided. The computer program product includes computer instructions. The computer instructions are stored in a computer-readable storage medium. A processor of a computer device is configured to read the computer instructions from the computer-readable storage medium, and the processor is configured to execute the computer instructions to cause the computer device to implement the configuration determination method according to any one of the above aspects, and/or the capability reporting method according to any one of the above aspects, and/or the period configuration method according to any one of the above aspects.

According to one aspect of the present disclosure, a chip is provided. The chip includes a programmable logic circuit and/or program instructions. When the chip runs, it is configured to implement the configuration determination method according to any one of the above aspects, and/or the capability reporting method according to any one of the above aspects, and/or the period configuration method according to any one of the above aspects.

According to one aspect of the present disclosure, a computer program is provided. The computer program includes computer instructions, and a processor of a computer device is configured to execute the computer instructions to cause the computer device to implement the configuration determination method according to any one of the above aspects, and/or the capability reporting method according to any one of the above aspects, and/or the period configuration method according to any one of the above aspects.

The technical solutions provided in the embodiments of the present disclosure at least include the following beneficial effects:

Through the first information field and the second information field of the first DCI, the first period configuration can be determined accurately, efficiently and flexibly, which is particularly applicable to the determination of the first period configuration when the number of period configurations is large.

By limiting the capability information of the UE, and/or limiting the total number of the period configurations configured by the network device, the problem that the first period configuration cannot be accurately determined due to an excessive total number of the period configurations can be avoided.

Those skilled in the art should realize that in one or more of the above examples, the functions described in the embodiments of the present disclosure may be implemented in hardware, software, firmware, or any combination thereof. When implemented in software, these functions may be stored in a computer-readable medium or transmitted as one or more instructions or codes on a computer-readable medium. The computer-readable media may include computer storage media and communication media, and the communication media includes any medium that facilitates the transfer of a computer program from one place to another. The storage medium may be any available medium that may be accessed by a general-purpose or special-purpose computer.

The above description is only optional embodiments of the present disclosure and is not intended to limit the present disclosure. Any modification, equivalent replacement, improvement, etc., made within the spirit and principle of the present disclosure shall be included in the protection scope of the present disclosure.

1. A configuration determination method, performed by a User Equipment (UE), the method comprising:
receiving a first Downlink Control Information (DCI), wherein the first DCI comprises a first information field and a second information field, and the first information field and the second information field are used to determine a first period configuration,
wherein the UE is configured with N sets of period configurations, the N sets of period configurations comprise the first period configuration, and N is an integer greater than 1.

2. The method of claim 1, wherein the N sets of period configurations comprise a first-type period configuration, and/or a second-type period configuration,
wherein a period determined according to the first-type period configuration comprises a plurality of transmission opportunities, and a period determined according to the second-type period configuration comprises one transmission opportunity.

3. The method of claim 1, wherein the first information field and the second information field are used to determine number information of the first period configuration,
wherein a bit of the first information field is a low bit, and a bit of the second information field is a high bit.

4. The method of claim 3, wherein the N sets of period configurations comprise a second period configuration and a third period configuration,
wherein a number of the second period configuration is different from a number of the third period configuration, the second period configuration is any one of the N sets of period configurations, and the third period configuration is any one of the N sets of period configurations except the second period configuration.

5. The method of claim 1, wherein the first information field is used to determine number information of the first period configuration, and the second information field is used to determine number group information or type information of the first period configuration.

6. The method of claim 5, wherein a number of the first-type period configuration corresponds to a first number group, and a number of the second-type period configuration corresponds to a second number group.

7. The method of claim 5, wherein the number of the first-type period configuration is less than or equal to a first value, and the number of the second-type period configuration is less than or equal to a second value,
wherein the first value is 15, and/or the second value is 15.

8. The method of claim 1, wherein the period configuration comprises a Configured Grant (CG) configuration, or a Semi-Persistent Scheduling (SPS) configuration.

9. The method of claim 1, wherein the first information field comprises a Hybrid Automatic Repeat Request (HARQ) process number information field, and the second information field comprises a Redundancy Version (RV) information field.

10. The method of claim 1, wherein
in a case that the first DCI is used to activate a period configuration, the first information field and the second information field are used to determine the activated first period configuration; or
in a case that the first DCI is used to deactivate a period configuration, the first information field and the second information field are used to determine the deactivated first period configuration.

11. A User Equipment (UE), comprising:
a processor; and
a memory configured to store instructions executable by the processor,
wherein the processor is configured to load and execute the instructions to:
receive a first Downlink Control Information (DCI), wherein the first DCI comprises a first information field and a second information field, and the first information field and the second information field are used to determine a first period configuration,
wherein the UE is configured with N sets of period configurations, the N sets of period configurations comprise the first period configuration, and N is an integer greater than 1.

12. The UE of claim 11, wherein the N sets of period configurations comprise a first-type period configuration, and/or a second-type period configuration,
wherein a period determined according to the first-type period configuration comprises a plurality of transmission opportunities, and a period determined according to the second-type period configuration comprises one transmission opportunity.

13. The UE of claim 11, wherein the first information field and the second information field are used to determine number information of the first period configuration,
wherein a bit of the first information field is a low bit, and a bit of the second information field is a high bit.

14. The UE of claim 13, wherein the N sets of period configurations comprise a second period configuration and a third period configuration,
wherein a number of the second period configuration is different from a number of the third period configuration, the second period configuration is any one of the N sets of period configurations, and the third period configuration is any one of the N sets of period configurations except the second period configuration.

15. The UE of claim 11, wherein the first information field is used to determine number information of the first period configuration, and the second information field is used to determine number group information or type information of the first period configuration.

16. The UE of claim 15, wherein a number of the first-type period configuration corresponds to a first number group, and a number of the second-type period configuration corresponds to a second number group.

17. The UE of claim 15, wherein the number of the first-type period configuration is less than or equal to a first value, and the number of the second-type period configuration is less than or equal to a second value,
wherein the first value is 15, and/or the second value is 15.

18. The UE of claim 11, wherein the period configuration comprises a Configured Grant (CG) configuration, or a Semi-Persistent Scheduling (SPS) configuration.

19. The UE of claim 11, wherein the first information field comprises a Hybrid Automatic Repeat Request (HARQ) process number information field, and the second information field comprises a Redundancy Version (RV) information field.

20. The UE of claim 11, wherein
in a case that the first DCI is used to activate a period configuration, the first information field and the second information field are used to determine the activated first period configuration; or
in a case that the first DCI is used to deactivate a period configuration, the first information field and the second information field are used to determine the deactivated first period configuration.
